(19) United States
(12) Patent Application Publication
(10) Pub. No.: US 2005/0061090 A1
(43) Pub. Date: Mar. 24, 2005

(54) System and method for the detection of a defect in a drive belt

(76) Inventors: Klaus Oberndorfer, Erlangen (DE); Manfred Zah, Forchheim (DE)

Correspondence Address: WHITE & CASE LLP;PATENT DEPARTMENT, 1155 AVENUE OF THE AMERICAS, NEW YORK, NY, 10036, US

(21) Appl. No.: 10/920,859

(22) Filed: Aug. 18, 2004

(30) Foreign Application Priority Data
Aug. 21, 2003 (DE) 10338492.8

(51) Int. Cl. B29B 13/00

(52) U.S. Cl. 73/865.9; 425/136

(57) ABSTRACT

The invention relates to a drive system (1) which has an electrical machine (3) and a belt drive (2), with the belt drive (2) having an input drive end (20) and an output drive end (22), in which case the input drive end (20) can be driven by means of the electrical machine (3), and in which case at least one electric current in the electrical machine (3) can be measured by means of a current measurement device (12). According to the invention, a means is provided for defect identification (13) for the belt drive (3), with the means for defect identification (13) being provided at least for comparison of at least one actual value (51) with at least one nominal value (52), and with the actual value (51) and the nominal value (52) being a variable which is dependent on the electric current in the electrical machine (3). Defect identification of a belt drive (2) can thus be achieved in a simple manner.

The invention relates to a drive system which has a belt drive, in which case a defect in this belt drive can be detected. A defect in the belt drive is, in particular, a crack in the drive belt.

In automation systems, such as a production machine, a machine tool or an automatic handling machine, belt drives are used to transmit movements and forces. A belt drive has, for example, a drive belt, a guide roller at the input drive end and a guide roller at the output drive end. One example of a production machine is a plastic injection-molding machine, or else a plastic blow-molding machine. In machines and automatic handling machines such as these as well, a drive belt, for example, connects an electrical machine, such as a servo motor, to a machine element which can move or else is to be moved. One example of an element such as this is a tool. The drive belt is subject to high forces during acceleration phases as well as during braking phases. High forces also occur when high torques have to be applied, even when the acceleration levels are low and even at rest. This relates in particular to processes where something is clamped in, or is to be firmly clamped. Loads to which a drive belt is subject can lead to the drive belt becoming defective, in particular to cracking of the drive belt. If a drive belt cracks while power is being transmitted, this can lead to damage. In order to minimize any damage, it is necessary to identify a defect or a crack in the drive belt as soon as possible. This relates in particular to injection-molding machines, where a crack in the drive belt must be identified in good time in order to prevent greater damage, particularly when using core pullers. A defect in a belt drive also occurs, for example, when prestressing which is provided for the drive belt becomes weaker. The prestressing can become weaker, for example, as a result of material fatigue of the drive belt and can thus be caused by lengthening of the drive belt. A further reason for prestressing to become weaker is, for example, a detached guide roller or a change in the positioning of a guide roller for the drive belt of the belt drive.

Until now, it has been possible to identify a crack in the drive belt not only by the electrical machine having a transmitter signal at the input drive end of the drive belt but also by an element that is moved by the output drive end having a transmitter. The signals from the transmitter at the output drive end of the drive belt are compared with the transmitter signals at the input drive end of the drive belt. If the two transmitter signals differ from one another to an unacceptable extent, then a crack in the drive belt is detected. Once the crack in the drive belt has been identified, it is possible, in particular, to stop the input drive end of the drive belt. Further functions of an automation system, that is to say of a machine tool, a production machine or of an automatic handling machine, can be selected in a corresponding manner once a crack in the drive belt has been identified. The use of a transmitter for the moving element at the output drive end of the drive belt is costly. Furthermore, the use of a transmitter such as this for identification of a crack in the drive belt leads to an increase in the failure probability of the entire automation system.

The object of the present invention is to improve the identification of a defect in a belt drive.

This object is achieved by a drive system having the features as claimed in claim 1. Developments of the drive system as claimed in claim 1 can be found in the respective features of the dependent claims 2 to 4. The object is also achieved by an automation system having the features as claimed in claim 5. Developments of the automation system according to the invention can be found in claims 6 to 8. The object is also achieved by a method for identification of a defect in a belt drive having the features as claimed in claim 9. Claims 10 to 14 represent developments of the method.

In the case of a drive system which has an electrical machine and a drive belt, the object is to detect a defect in the belt drive. The electrical machine is, for example, a servo motor. The belt drive has an input drive end and an output drive end, in which case the input drive end can be driven by means of the electrical machine. The electric current which is drawn by the electrical machine can be measured by means of a current measurement device. If the electrical machine has connections to different phases of the electrical power supply, then at least one of the phases, or two of the phases in the case of a three-phase machine, can be measured by means of the current measurement device. A means for defect identification is provided in order to identify a defect in the belt drive. The belt drive in this case has at least one drive belt. The means for defect identification is provided for comparison of at least one actual value with at least one nominal value. The actual value and the nominal value are dependent on a variable which is dependent on the electric current in the electrical machine. A defect in the belt drive is, in particular, a crack in the drive belt or else a change in the prestressing of the drive belt. The prestressing of the drive belt may result, for example, from the positions of guide rollers for the drive belt becoming detached, or else from expansion of the drive belt as a consequence of wear. The problem of excessively low prestressing occurs in particular in the case of drive belts which have no tooth system. Toothed belts as drive belts are less sensitive in this context.

A defect in the belt drive can advantageously be identified by evaluation of an actual value of a variable which is dependent on the electric current in the electrical machine. This is done by evaluation of the discrepancy between the measured actual values and nominal values, which can be stored, in particular, in the defect identification means. Discrepancy is, for example, not only an increase in the actual value with respect to the nominal value, but also a decrease in the actual value with respect to the nominal value.

In one refinement, the discrepancy between the actual value and the nominal value is measured at a specific time, with at least one electric current in one phase being used as the actual value and as the nominal value. If the difference between the actual value and the nominal value exceeds a specific predetermined value, then a defect in the belt drive is identified, and, for example, the electrical machine is then stopped.

In one advantageous refinement, the actual value and the nominal value are a value which is integrated over time. This makes it possible to compensate for short-term sudden changes in the profile of the actual value over a predetermined or selectable time constant for integration, so that this does not lead to spurious identification of defects in the belt drive.

In one advantageous refinement, the current measurement device is integrated downstream from a converter. Converters or else inverters generally already have a current measurement device for controlling the connected electrical machine. A component which already exists in the drive system can thus be used for identification of a defect in the belt drive. There is therefore no longer any need for any additional device, for example an additional transmitter, for identification of a defect such as this.

In a further advantageous refinement, the defect identification means is also integrated in the converter. The integration process is, in particular, software integration of the functionality, using the hardware of the existing converter.

The drive system may be used, for example, in a plastic injection-molding machine or in a blow-molding machine. In this case, the output drive end of the belt drive is, in particular, mechanically coupled to a spindle. The spindle can be used to drive an element which is required to carry out the injection process. During an injection process, there are various critical processes which cannot be carried out in the presence of a defect, and which can thus result in high repair costs as a result of damage. One example of this is the shifting of core pullers, in particular for undercuts in the case of plastic injection-molding machines.

In one advantageous refinement, the electric currents are measured at the interpolation clock rate of the rotation speed regulator or of the position regulator for one shaft, or even at the regulator clock rate of the converter. This allows high-precision detection of a defect in the belt drive. Random noise can be averaged out by integration of an actual value of the electric current over time. The plastic injection-molding machine is one example of a machine which has a drive system in which the drive system carries out repeatedly recurring movement sequences, with the movement sequences which are carried out recurrently allowing the use and storage of the nominal values.

The invention relates not only to a drive system but also to a corresponding automation system which has a drive system with a belt drive. Examples of automation systems are production machines, machine tools or automatic handling machines.

In one method for identification of a defect in a belt drive, an electric current in the electrical machine which drives the belt drive at an input drive end is measured. In addition to the input drive end, the belt drive also has an output drive end. At least one actual value is compared with at least one nominal value for defect identification. The actual value and the nominal value are variables which are dependent on the measured electric current in the electrical machine. A belt drive defect is identified when there is a predetermined discrepancy between the actual value and the nominal value.

As has already been described above, an integration value is advantageously used for identification of a defect.

At least one reference run of the electrical machine is carried out in order to obtain the nominal value or values. The nominal values are determined during the reference run or runs. This also results in particular in a range of possible actual values which are permissible. The reference run is, for example, one complete cycle of a plastic injection-molding machine in the automatic mode. The complete cycle, which has to be carried out without any problems, can be stored as a reference, that is to say as a reference run. Particularly when the belt drive is subject to wear, the actual values creep out of the range of possible permissible actual values, with the range being predetermined by the nominal values from the reference runs. If this range is left in an unacceptable manner, which can be predetermined, then a belt drive defect is confirmed. This defect is confirmed, for example, by an indication on a control panel or by a bit to be set in a control word. Machine reactions which can be predetermined can be stored in a controller on the basis of such defect identification.

For successful defect identification of the belt drive, it is necessary to carry out an electrical machine run which is equivalent to the reference runs during the run which leads to the measurement of the actual values.

The described defect identification is thus based in particular on the following approach:
measurement of the actual values, for example of the motor torque and/or of the motor current,
if the movement sequence is permissible, declaration of the measured actual values as nominal values,
comparison of subsequent movement cycles by comparison of the actual values for the electrical machine (for example of the motor torque and/or of the motor current) with the nominal values,
if a discrepancy occurs which is beyond the permissible tolerances, a fault is detected by software and, for example, a machine is stopped.

If an electrical machine carries out different movement sequences depending on the specific state of the automation system in which the electrical machine is installed, then different movement phases with different nominal value profiles are also required. One example of this is a plastic injection-molding machine, in which the mold has to be stopped in various positions in order to move core pullers in and out. In the case of a plastic injection-molding machine, a distinction must also be drawn between different ejection processes.

Advantages of the invention are, for example:
the simple calculation of a defect in the belt drive,
an immediate reaction to a tolerance limit being exceeded, and
initiation of defect signaling, associated with this.

Rapid reaction to a defect is possible in particular when integrated values are not used for the actual values and/or nominal values. This is advantageously done in situations in which small or else large changes occur in the inertia, friction, or in the load.

In one advantageous refinement, actual values and/or nominal values which have been integrated over time are used to identify a defect in the belt drive. For example, monitoring software integrates the motor torque over time. The motor torque of the electrical machine in this case relates in particular to one shaft of a drive system. The integrated values are stored as nominal values when a successful movement procedure takes place. Averaging over different nominal values can also be carried out. Measured actual values and/or the integrated actual values are then compared with the stored nominal values. In the situation where a permissible tolerance is exceeded, monitoring software, in particular, trains the means for defect identification to stop the electrical machine immediately and to emit a fault.

The integral is, for example, as follows:

$$IRC = {\int }_{t = 0}^{t = t} \vert {m}_{F} \vert * ⅆ t$$

where t: time
mF: actual value of the motor torque

The use of a time integral has the advantage that short-term discrepancies between the actual value and the nominal value do not lead to triggering of the defect identification. A tolerance band around possible nominal values can advantageously be configured, in which case it is possible to set a tolerance band value representing, for example, a 5% discrepancy.

One exemplary embodiment of the invention is illustrated in the drawings, in which:

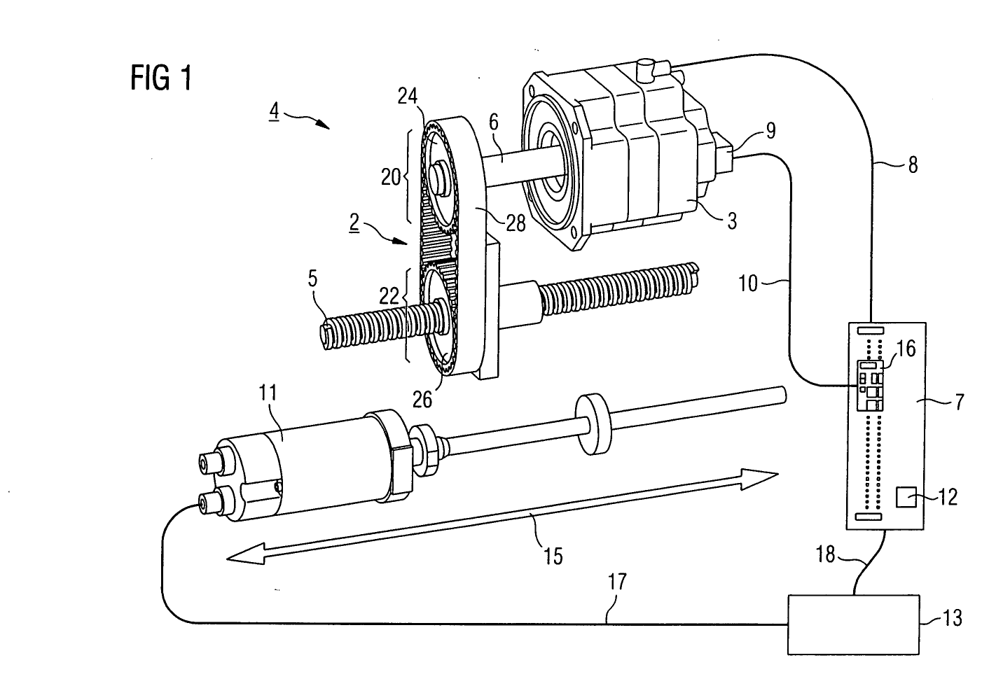

FIG. 1 shows crack identification for a drive belt based on the prior art, and

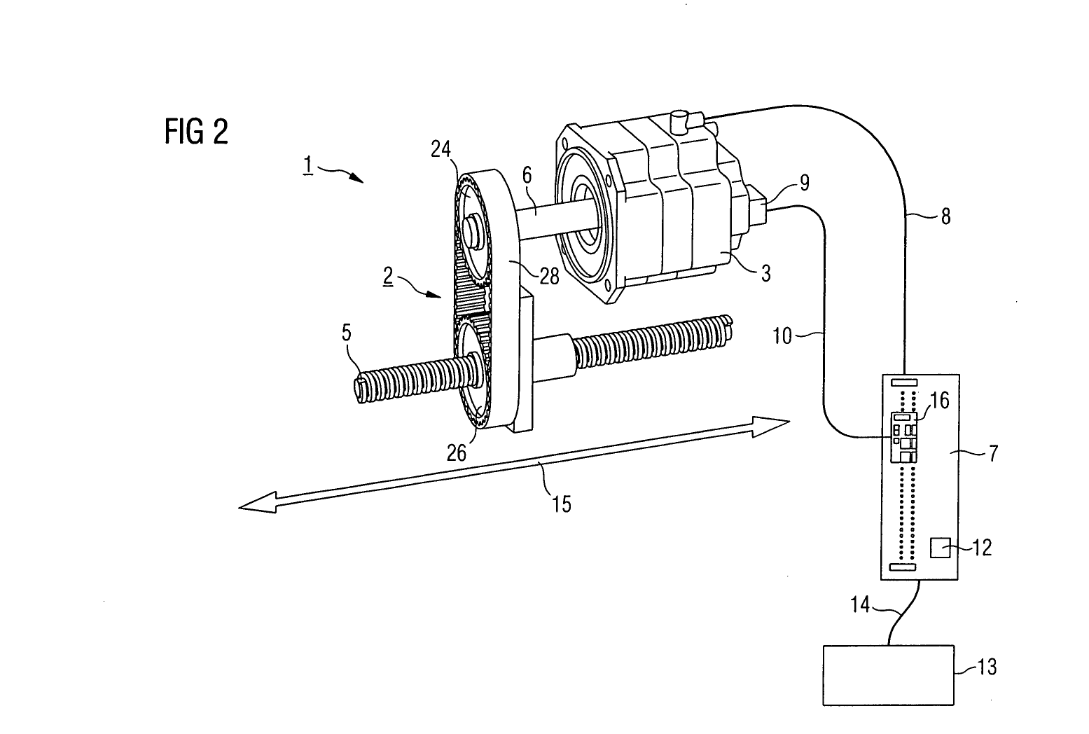

FIG. 2 shows crack identification according to the invention for a drive belt, and

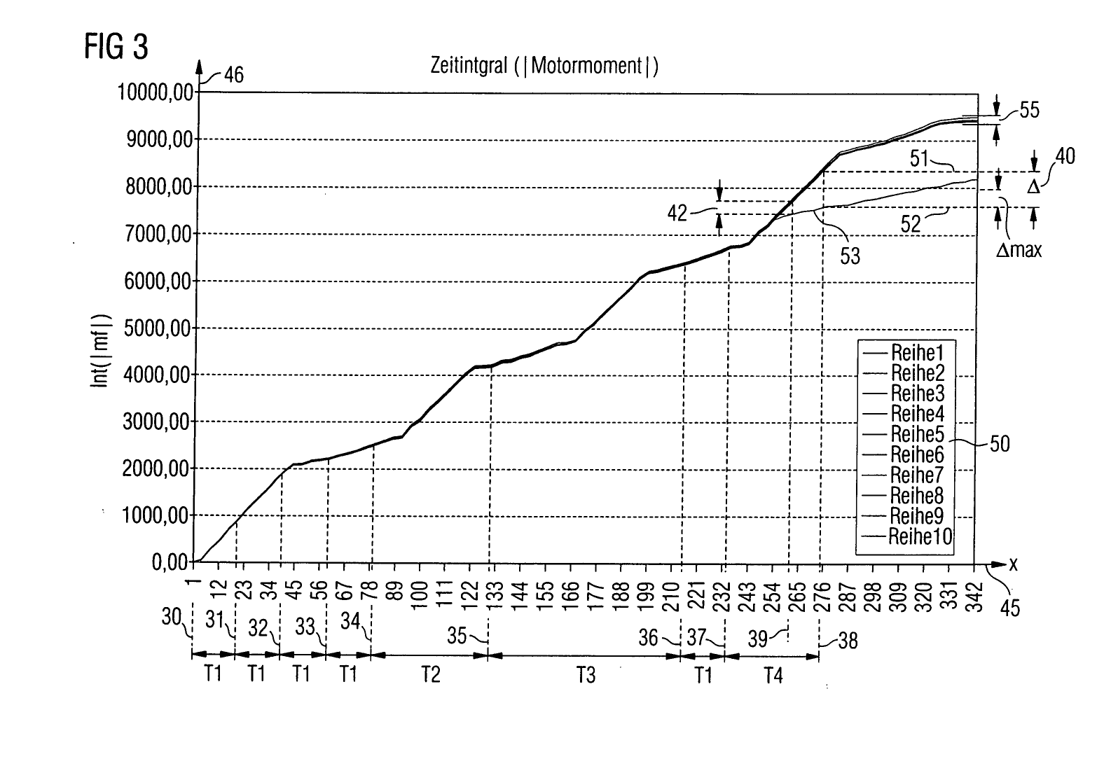

FIG. 3 shows an integral of the motor torque over time.

The illustration in FIG. 1 shows a drive system 4 according to the prior art. The drive system 4 has a belt drive 2. The belt drive 2 has a drive belt 28, with the drive belt 28 being guided by means of an input drive end guide roller 24 at the input drive end 20, and being guided by means of an output drive end guide roller 26 at the output drive end 22. The guide roller 24 at the input drive end can be driven by means of an electrical machine 3. A shaft 6 is provided for power transmission. The output drive end 22 is intended to drive a spindle 5. Movement of the spindle 5 can be measured by means of a position sensor 11, as is indicated by the symbolic illustration. A linear movement, which can be carried out by means of the spindle 5, of a machine part that is not illustrated can be measured with the aid of the position sensor 11. Possible movement directions 15 are indicated by an arrow. The electrical machine 3 which, for example, is a servo motor can be fed via a converter 7 by means of a power cable 8. The converter 7 is also intended, for example, to control the electrical machine 3. For rotation speed control and position control of the electrical machine 3, the machine has a motor sensor 9 which is connected to the converter 7 via a sensor cable. The converter 7 has a regulator 16 for controlling the electrical machine 3. Furthermore, the converter 7 has a current measurement device 12.

The sensor signal from the position sensor 11, which can be transmitted to the means 13 by means of a data cable 17, is processed with the signal from the motor sensor 9 in a means for defect identification 13 which, for example, is a programmable logic controller or a movement controller. The signal from the motor sensor 9 is transmitted via the converter 7 and the data cable 18. The means for defect identification 13 identifies a crack in the drive belt 28 by evaluation of the two sensor signals from the sensors 11 and 9.

The illustration in FIG. 2 shows a drive system 1 according to the invention in which the means for defect identification 13 compares nominal values and actual values, with the nominal values and actual values being dependent on the real current in the electrical machine 3. The means for defect identification 13, which is illustrated separately in FIG. 2, can also been integrated in other control and regulation devices in the form of software or hardware. Integration is feasible, for example, in the following components: a converter, a movement controller, a movement regulator, a programmable logic controller, or the like. Integration such as this is not illustrated in FIG. 3.

During an acceleration process and during a braking process, the behavior of the real power which is consumed by an electrical machine 3 during the movement depends in particular on the inertia of the electrical machine 3 and on the inertia of moving machine elements. The amount of real power consumed decreases as the inertia is reduced. During a movement at a constant velocity, the behavior of the real power consumed by the electrical machine 3 is governed by the friction and the occurrence of external forces. External forces are, for example, forces which are required within a production process, such as the formation of a force for clamping in an object or, for example in the case of plastic injection-molding machine, the force for injection of a plastic substance. In the situation where a crack occurs in the drive belt 28, this leads to a reduction in the friction forces and in the inertia forces which the electrical machine 3 has to overcome, since fewer mechanical elements have to be moved by the electrical machine 3. This leads to the power consumption of the electrical machine being reduced. When the power consumption of the electrical machine 3 is reduced, the electric currents which are drawn by the electrical machine 3, in particular real currents, are also reduced.

In the event of a crack in the drive belt 28, an external load is separated from the electrical machine 3. In principle, this also leads to a function of the real power consumed by the electrical machine 3. On the basis of this analysis, it can be stated that the behavior of the motor torque, in particular the magnitude of the motor torque, changes in the event of a crack in the drive belt 28. The absolute magnitude of the motor torque and of the torque which is applied by the electrical machine 3 (which, for example, is a motor) decreases in the event of a crack in the drive belt 28. The magnitude of the change in the torque of the electrical machine 3, and in the real power consumed by it or the real currents drawn by it, depends, for example, on the following points: the magnitude of the change in the inertia, the magnitude of the change in the friction forces to be overcome, and the magnitude of the forces to be overcome in a process such as an injection process in a plastic injection-molding machine or a blow-molding machine.

In consequence, the behavior of the torque of the electrical machine or of a value which is linked to it, such as the real power consumed or the electric currents, in particular the real currents in the electrical machine, is used as a criterion for a defect in the drive belt 28. One example of a defect is a crack in the drive belt 28 or else a change in the prestressing of the drive belt 28. If the prestressing of a drive belt 28 is too low, this can lead to slipping and to increased wear of the drive belt 28. The expression the behavior of the corresponding variables in this case means, in particular, their profile. A profile can be represented, for example, by a series of values or by a diagram.

There are various approaches to the monitoring of a drive system or of a belt drive. These approaches can be used for different automation solutions, although the dependency on the electric current is always made use of. Since the torque of the electrical machine depends on the current which is drawn by the electrical machine, this current can be used to monitor the belt drive.

The means for detect identification is, for example, integrated in a man machine interface (Human Machine Interface, HMI), or in a controller for a machine.

The illustration in FIG. 3 shows a diagram in which time is plotted on an x axis 45, and the integral of the magnitude of a motor torque Int (/mf/) is plotted on a y axis 46. In the legend 50, the illustration shows ten series, series 1 to series 10, with the series in the diagram being very close to one another, so that it is difficult to distinguish between them. The series originate from movement sequences of the same type which recur repeatedly. One example of a movement such as this is picking elements up and placing them down, or the injection of an injection substance in the case of a plastic injection-molding machine. In this case, the number of shafts monitored is irrelevant. The described monitoring of the belt drive can be carried out only for recurrent movement sequences. The series show the integral of the magnitude of the motor torque during reference runs. Obviously, the motor torque is not subject to any discrepancies during reference runs with functional drive belts. Any fluctuations are advantageously compensated for by the integration function. Different integration sections can also be formed for different movement sections.

The graphs for the series 1 to 10 in the time from 1 to about 280 are close to one another, so that there is only a single graph in the entire illustration. A split in the graph 54 can be seen in a subsequent time period from about 280 to 342. Such splitting of the graph makes it possible to show a tolerance band 55. As long as the series are within a tolerance band 55, this does not result in any identification of a defect in the belt drive. The x axis 45, on which the time is shown, can be subdivided into different time periods or times. The times 30, 31, 32, 33, 34, 35, 36, 37 and 38 indicate, for example, times for time periods T1, T2, T3 and T4. The illustration shows that monitoring can be carried out not only at all of the times 1 to 342 but also at selected times 30 to 38. Different maximum discrepancies between the nominal values 52 and actual values 51 can also be provided for the time periods T1 to T4. A crack is assumed to occur in the drive belt 28 in the time period T4. The crack results in the actual value curve deviating from the nominal value curve, that is to say from the series 1 to 10. If, by way of example, monitoring is carried out at the time 38, then it is evident that the actual value differs from the nominal value by the discrepancy 40. This Δ of the discrepancy 40 is greater than the maximum permissible discrepancy 42 of Δmax. A crack in the drive belt 28 is identified from this maximum permissible discrepancy 42 being exceeded. If the monitoring of the drive belt 28 is carried out not only at the times 30 to 38 but also within the time periods T1 to T4, then a crack such as this in the drive belt 28 is in fact identified earlier, at a time 39.

If creeping wear of the drive belt 28 is assumed, leading to a continuous increase in the motor torque to be applied by the motor, then the actual values would be greater than the nominal values, although this is not illustrated in FIG. 3. In a situation such as this, a defect in a drive belt can also be identified by the maximum discrepancy between the actual value and the nominal value being exceeded.

1-15. (canceled)

16. A method of detecting a defect in a drive belt comprising the steps of:
measuring an electric current that is associated with a motor having a rotor that is coupled to the drive belt;
comparing an actual value of a parameter that is a function of the electric current to a nominal value of that parameter; and
determining if a discrepancy between the actual value and the nominal value exceeds a threshold value.

17. A method according to claim 16 wherein:
the actual value comprises an integral of the parameter over a time range.

18. A method according to claim 17 wherein:
the parameter comprises an absolute value of a magnitude of the electric current.

19. A method according to claim 16 wherein:
the actual value comprises an instantaneous value of the parameter; and
the step of comparing comprises integrating a difference between the actual value and the nominal value over a time a range.

20. A method according to claim 19 wherein:
the nominal value varies as a function of time over the range.

21. A method according to claim 16 wherein:
the parameter comprises a magnitude of motor torque.

22. A method according to claim 21 wherein:
the actual value comprises an integral of the magnitude of motor torque over a time range.

23. A method according to claim 16 wherein:
the parameter comprises a magnitude of real power being consumed by the motor.

24. A method according to claim 16 wherein:
the parameter comprises a function of at least one variable in addition to the electric current.

25. A method according to claim 24 wherein:
the at least one variable comprises a rotational speed.

26. A method according to claim 16 further comprising the step of:
determining the nominal value.

27. A method according to claim 26 wherein:
the step of determining the nominal value comprises performing a reference run.

28. A method according to claim 16 further comprising the step of:
turning off the motor if the discrepancy exceeds the threshold value.

29. A method according to claim 28 further comprising the step of:
stopping a manufacturing process if the discrepancy exceeds the threshold value.

30. A method according to claim 16 further comprising the step of:
providing an indication on a control panel that the threshold has been exceeded.

31. A method according to claim 16 further comprising the step of: selecting the nominal value from a plurality of predetermined possible values.

32. A method according to claim 31 wherein:
the step of selecting the nominal value comprises identifying a state of a machine of which the drive belt is a component.

33. A method according to claim 16 further comprising the step of:
identifying a defect in the drive belt based on the discrepancy between the actual value and the nominal value.

34. A belt drive system comprised of:
a drive belt;
a motor;
a means for measuring an electric current associated with the motor; and
a processor configured to calculate a discrepancy between an actual value of a parameter that is a function of the electric current and a nominal value for the parameter.

35. The belt drive system of claim 34 wherein:
the actual value comprises an integral of the parameter over a time range.

36. The belt drive system of claim 34 further comprising:
a rotation speed regulator;
wherein the parameter comprises a function of a speed signal from the rotation speed regulator.

37. The belt drive system of claim 34 further comprising:
an internal clock;
wherein the actual value is sampled in accordance with a signal from the internal clock.

38. The belt drive system of claim 37 wherein: the nominal value is a function of time measured in accordance with the internal clock.

39. The belt drive system of claim 38 wherein:
the function of time is specified by performing a reference run on an automation system of which the belt drive system is a component.

40. The belt drive system of claim 38 wherein:
the discrepancy is calculated by integrating the absolute value of the difference between the actual value and the nominal value over a time range.

41. The belt drive system of claim 34 further comprising:
a converter.

42. The belt drive system of claim 41 wherein:
the means for measuring an electric current is located in the converter.

43. The belt drive system of claim 41 wherein:
the actual value is integrated over a time range by software running in the converter.

44. An automation system comprising:
a belt drive comprising a motor and a belt;
a current measurement device for measuring an electric current associated with the belt drive; and
a means to calculate a discrepancy between an actual value of a parameter that comprises a function of the electric current and a nominal value for the parameter.

45. The automation system of claim 44 wherein:
the automation system comprises an injection molding machine.

46. The automation system of claim 44 wherein:
the nominal value is determined by conducting a reference run on the injection molding machine.

47. The automation system of claim 46 wherein:
the reference run entails performing a plurality of functions that occur at specific times;
the nominal value varies as a function of time; and
the range of the function comprises of a plurality of discrete values corresponding to the plurality of functions.
